(19) United States
(12) Patent Application Publication
(10) Pub. No.: US 2024/0416374 A1
(43) Pub. Date: Dec. 19, 2024

(54) TRIGGER-TYPE LIQUID SPRAYER

(71) Applicant: YOSHINO KOGYOSHO CO., LTD., Tokyo (JP)

(72) Inventors: Kota SAKATA, Tokyo (JP); Kotaro FUJIWARA, Tokyo (JP); Shigeru HAYAKAWA, Tokyo (JP)

(73) Assignee: YOSHINO KOGYOSHO CO., LTD., Tokyo (JP)

(21) Appl. No.: 18/704,676

(22) PCT Filed: Oct. 26, 2022
(86) PCT No.: PCT/JP2022/039974

§ 371 Date: Apr. 25, 2024

(30) Foreign Application Priority Data
Oct. 29, 2021 (JP) 2021-177973
Dec. 28, 2021 (JP) 2021-214794

(51) Int. Cl. B05B 11/10

(52) U.S. Cl. CPC B05B 11/1011

(57) ABSTRACT

A trigger-type liquid sprayer including: a sprayer main body; and a nozzle member. The sprayer main body includes: a vertical supply cylindrical part; a trigger mechanism; a reservoir cylinder; and a reservoir plunger. The trigger mechanism includes: a main cylinder; a main piston; and a biasing member.

### TECHNICAL FIELD

The present invention relates to a trigger-type liquid sprayer. Priority is claimed on Japanese Patent Application No. 2021-214794 filed on Dec. 28, 2021, and Japanese Patent Application No. 2021-177973 filed on Oct. 29, 2021, the contents of which are incorporated herein by reference.

### BACKGROUND ART

Trigger-type liquid sprayers that suck up a liquid from the inside of a container body by operating a trigger part and spray the liquid through a spray hole are known. A trigger-type liquid sprayer disclosed in Patent Document 1 below includes a piston that moves back and forth according to the movement of a trigger part, a cylinder of which the inside is pressurized and depressurized according to the movement of the piston and communicates with the inside of a vertical feed tube portion, and a biasing member that is disposed inside the cylinder and biases the trigger part forward via the piston.

Further, the trigger-type liquid sprayer disclosed in Patent Document 1 below includes a reservoir cylinder into which a liquid having passed through the inside of the vertical feed tube portion is supplied by the rearward movement of the trigger part, and a reservoir plunger that is disposed inside the reservoir cylinder and that moves toward one side in the axial direction and is biased toward the other side according to the supply of the liquid into the reservoir cylinder, so that the liquid can be continuously sprayed.

### CITATION LIST

### Patent Document

### [Patent Document 1]

Japanese Unexamined Patent Application, First Publication No. 2021-159841

### SUMMARY OF INVENTION

### Technical Problem

The trigger-type liquid sprayer is required to continuously spray various types of liquids, such as a mold removing agent containing hypochlorite used in bathrooms. However, depending on the type of liquid, a biasing member that comes into contact with the liquid may deteriorate, making the movement of the piston or the operation of the trigger part slow or degrading the liquid itself due to contact with the biasing member.

Furthermore, in a trigger-type liquid sprayer of the related art, a front end of a piston is brought into contact with a trigger part so that the piston, which is biased forward by a biasing member, does not move forward out of a cylinder. However, before the trigger part is assembled, the forward movement of the piston cannot be restricted, and when the assembly accuracy of the trigger part varies or changes, the piston may move forward beyond its designed forwardmost position, causing the possibility of liquid leakage or the like. Further, when the piston moves forward beyond the designed forwardmost position, there is a possibility that the piston will not retreat to a designed rearmost position at the time of performing an operation of pulling the trigger part.

The present invention has been made in view of the above circumstances, and an object thereof is to provide a trigger-type liquid sprayer capable of suppressing contact between a biasing member that biases a trigger part and a liquid, continuously spraying the liquid, and restricting the forward movement of a piston regardless of the assembled state of the trigger part.

### Solution to Problem

A first aspect of the present invention is a trigger-type liquid sprayer including: a sprayer main body mounted to a container body in which a liquid is accommodated; and a nozzle member mounted to the sprayer main body, and provided with a spray hole through which the liquid is sprayed, in which the sprayer main body includes: a vertical feed tube portion configured to suck up the liquid in an inside of the container body, a trigger mechanism having a trigger part disposed to be movable rearward in a forward biased state, and configured to flow the liquid toward the spray hole from an inside of the vertical feed tube portion according to rearward movement of the trigger part, a reservoir cylinder into which the liquid passing through the inside of the vertical feed tube portion is supplied according to the rearward movement of the trigger part, and a reservoir plunger disposed in an inside of the reservoir cylinder to be movable in an axial direction along a central axis of the reservoir cylinder, and configured to move toward one side in the axial direction according to supply of the liquid into the inside of the reservoir cylinder, and biased toward the other side, and the trigger mechanism includes: a main cylinder opening at a front, and communicating with the inside of the vertical feed tube portion at a rear, a main piston that includes: a sliding part disposed in an inside of the main cylinder to be movable in a front-rear direction, and a protrusion part protruding forward from the sliding part toward an outside of the main cylinder, and a front end of which is connected to the trigger part, and a biasing member into which the protrusion part of the main piston is inserted, and biasing the trigger part forward.

According to the trigger-type liquid sprayer according to the first aspect of the present invention, the trigger part is operated to be moved rearward, and thus the liquid can be made to flow from the inside of the vertical feed tube portion toward the spray hole. Thereby, the liquid can be sprayed outward through the spray hole of the nozzle member. Moreover, the liquid can be supplied into the reservoir cylinder from the inside of the vertical supply cylinder to pressurize the inside of the reservoir cylinder. Thus, the reservoir plunger can be pressed toward one side in the axial direction against a biasing force directed toward the other side in the axial direction, and the reservoir plunger can be moved toward one side in the axial direction while spraying the liquid. For this reason, each time an operation of pulling the trigger part is performed, the reservoir plunger is moved to one side in the axial direction, and the liquid can be sprayed while being stored in (filling) the reservoir cylinder. When the operation of the trigger part is stopped after filling the reservoir cylinder with the liquid, the supply of the liquid into the reservoir cylinder through the vertical feed tube portion is stopped, but the reservoir plunger begins to be restored and moved toward the other side in the axial direction. Thereby, the liquid filled in the reservoir cylinder can be pushed out from the inside of the reservoir cylinder toward the spray hole and can be sprayed from the spray hole. Thus, it is possible to continuously spray the liquid.

Incidentally, the trigger part is biased forward by the biasing member. In particular, the protrusion part of the main piston is inserted into the biasing member, protrudes outward from the front opening of the main cylinder, and has its front end connected to the trigger part. Thus, the trigger part can be biased by disposing the biasing member outside a space surrounded by the main cylinder and the main piston. Thereby, a liquid sucked up into the main cylinder does not come into contact with the biasing member and react with the liquid. Thus, it is possible to configure the trigger-type liquid sprayer that prevents deterioration of the biasing member and degradation of the liquid and is suitable for continuous spraying of the liquid.

A second aspect of the present invention is the trigger-type liquid sprayer according to the first aspect, the trigger-type liquid sprayer further including a spring receiver mounted to a front opening of the main cylinder and receives a rear end of the biasing member.

In this case, the spring receiver can be mounted to the front opening of the main cylinder, and the biasing member can be disposed between the spring receiver and the trigger part. Further, the spring receiver can restrict the main piston from coming out through the front opening of the main cylinder.

A third aspect of the present invention is the trigger-type liquid sprayer according to the second aspect, in which the spring receiver includes a pair of side wall parts sandwiching the biasing member in a right-left direction.

In this case, the biasing member disposed outside a space surrounded by the main cylinder and the main piston is sandwiched between the pair of right and left side wall parts to make it difficult to view the biasing member from the outside, and the design can be improved. Furthermore, it is possible to prevent a liquid or the like scattered by spraying from adhering to the biasing member by the pair of right and left side wall parts.

A fourth aspect of the present invention is the trigger-type liquid sprayer according to the second aspect or the third aspect, in which the spring receiver includes: an inner cylindrical part inserted into the main cylinder; and a receiving part formed inside the inner cylindrical part, and configured to receive the rear end of the biasing member.

In this case, the inner cylindrical part of the spring receiver is inserted into the main cylinder. For this reason, the spring receiver can be easily mounted to the main cylinder. Furthermore, it is possible to restrict forward coming-out of the main piston sliding inside the main cylinder by the inner cylindrical part inserted into the main cylinder.

A fifth aspect of the present invention is a trigger-type liquid sprayer including: a sprayer main body mounted to a container body in which a liquid is accommodated; and a nozzle member disposed on a front side of the sprayer main body, and provided with a spray hole through which the liquid is sprayed forward, in which the sprayer main body includes: a vertical feed tube portion extending in an up-down direction, and configured to suck up the liquid in an inside of the container body; and a trigger mechanism including a trigger part disposed in front of the vertical feed tube portion to be movable rearward in a forward biased state, and configured to flow the liquid toward the spray hole from the inside of the vertical feed tube portion, and the trigger mechanism includes: a main piston configured to move back and forth according to the movement of the trigger part; a main cylinder an inside of which is pressurized and depressurized according to the movement of the main piston, and the inside of which communicates with the inside of the vertical feed tube portion; a biasing member disposed in an inside of the main cylinder, and biasing the main piston forward; and a restriction member fitted to the main cylinder, and configured to restrict forward coming-out of the main piston.

According to the trigger-type liquid sprayer according to the fifth aspect of the present invention, when the trigger mechanism is operated and the trigger part is moved rearward, the inside of the main cylinder is pressurized due to the retreat of the main piston, and the liquid in the main cylinder flows from the inside of the vertical feed tube portion toward the spray hole. Thereby, the liquid can be sprayed forward through the spray hole of the nozzle member. Furthermore, when the operation of the trigger mechanism is stopped, the main piston moves forward together with the trigger part to depressurize the inside of the main cylinder because the biasing member biasing the main piston forward is provided inside the main cylinder, and the liquid can be sucked up from the inside of the container body. Here, the restriction member is fitted to the main cylinder, and forward coming-out of the main piston is restricted by the restriction member. For this reason, even when the trigger part is not yet assembled, the forward movement of the main piston can be reliably restricted. Further, the main cylinder, the biasing member, the main piston, and the restriction member can be assembled into a unit in advance. For this reason, it becomes easy to perform assembly to the sprayer main body

A sixth aspect of the present invention is the trigger-type liquid sprayer according to the fifth aspect, in which a guide tube guiding the main piston in a front-rear direction is provided in the inside of the main cylinder, and the main piston includes: an inner lip part configured to slide in contact with an outer wall surface of the guide tube; an outer lip part configured to slide in contact with an inner wall surface of the main cylinder; and a lip connection part connecting the inner lip part and the outer lip part, and the restriction member includes a restriction piece configured to abut on the lip connection part in the front-rear direction and restrict forward coming-out of the main piston.

In this case, the restriction piece of the restriction member directly abuts on the lip connection part, which connects the inner lip part and the outer lip part of the main piston, in the front-rear direction, and thus it is possible to restrict the forward movement of the main piston while preventing deformation of the inner lip part and the outer lip part. For this reason, it is possible to secure sliding performance and sealing performance of the main piston with respect to the guide tube and the main cylinder.

A seventh aspect of the present invention is the trigger-type liquid sprayer according to the fifth aspect or the sixth aspect, in which the restriction member includes: an outer cylindrical part externally fitted to the main cylinder; an inner cylindrical part connected to the outer cylindrical part, inserted into the main cylinder, and disposed on an entire circumference of an inner wall surface of the main cylinder with a gap therebetween; and a pair of groove parts formed on an outer circumferential surface of the inner cylindrical part, and extending in the front-rear direction.

In this case, the outer cylindrical part of the restriction member is externally fitted to the main cylinder, and thus the restriction member can be easily mounted to the main cylinder. Further, the inner cylindrical part of the restriction member is inserted into the main cylinder and is disposed on the entire circumference of the inner wall surface of the main cylinder with a gap therebetween, and the pair of groove parts extending in the front-rear direction are formed on the outer circumferential surface of the inner cylindrical part. Thus, the inner cylindrical part can be inserted at a predetermined position within the main cylinder to restrict the forward movement of the main piston regardless of the dimensional accuracy of the inner wall surface of the main cylinder.

An eighth aspect of the present invention is the trigger-type liquid sprayer according to any one of the fifth to seventh aspects, in which the biasing member is a metal spring, and the sprayer main body includes: a reservoir cylinder into which the liquid passing through the inside of the vertical feed tube portion from the main cylinder is supplied according to rearward movement of the trigger part; a reservoir plunger disposed in an inside of the reservoir cylinder to be movable in an axial direction along a central axis of the reservoir cylinder, configured to move toward one side in the axial direction according to the supply of the liquid into the inside of the reservoir cylinder, and biased toward the other side; a first check valve configured to block communication between the inside of the container body and the inside of the main cylinder through the inside of the vertical feed tube portion when the inside of the main cylinder is pressurized, and configured to allow communication between the inside of the container body and the inside of the main cylinder through the inside of the vertical feed tube portion when the inside of the main cylinder is depressurized; and a second check valve configured to allow communication between the inside of the reservoir cylinder and the inside of the main cylinder through the inside of the vertical feed tube portion when the inside of the main cylinder is pressurized, and configured to block communication between the inside of the reservoir cylinder and the inside of the main cylinder through the inside of the vertical feed tube portion when the inside of the main cylinder is depressurized.

In this case, the biasing member is configured as a metal spring, and thus it is possible to strengthen the sucking-up of the liquid into the main cylinder. Further, it is possible to spray the liquid through the spray hole while supplying the liquid into the reservoir cylinder through the inside of the vertical feed tube portion from the main cylinder by using the first check valve and the second check valve and to pressurize the inside of the reservoir cylinder. Thus, the reservoir plunger can be pressed toward one side in the axial direction against a forward biasing, and the reservoir plunger can be moved toward one side in the axial direction while spraying the liquid. For this reason, each time an operation of pulling the trigger part is performed, the reservoir plunger is moved to one side in the axial direction, and the liquid can be sprayed while being stored in (filling) the reservoir cylinder. When the operation of the trigger part is stopped after filling the reservoir cylinder with the liquid, the supply of the liquid into the reservoir cylinder through the vertical feed tube portion is stopped, but the reservoir plunger begins to be restored and moved toward the other side in the axial direction. Thereby, the liquid filled in the reservoir cylinder can be pushed out from the inside of the reservoir cylinder toward the spray hole and can be sprayed from the spray hole. Thus, it is possible to continuously spray the liquid.

### Effects of Invention

According to a trigger-type liquid sprayer according to the present invention, it is possible to suppress contact between a biasing member that biases a trigger part and a liquid, continuously spray the liquid, and restrict the forward movement of a main piston regardless of the assembled state of the trigger part.

### BRIEF DESCRIPTION OF DRAWINGS

FIG. 1 is a longitudinal cross-sectional view of a trigger-type liquid sprayer according to a first embodiment of the present invention.

FIG. 2 is an enlarged view of main parts of the trigger-type liquid sprayer shown in FIG. 1.

FIG. 3 is a front view of the trigger-type liquid sprayer according to the first embodiment of the present invention.

FIG. 4 is a side view of the trigger-type liquid sprayer according to the first embodiment of the present invention.

FIG. 5 is a side view showing a state in which a trigger part of the trigger-type liquid sprayer according to the first embodiment of the present invention is pulled.

FIG. 6 is a longitudinal cross-sectional view showing a trigger-type liquid sprayer according to a second embodiment of the present invention.

FIG. 7 is an enlarged view showing main parts of a trigger mechanism according to the second embodiment of the present invention.

FIG. 8 is a rear view showing a restriction member according to the second embodiment of the present invention.

FIG. 9 is a longitudinal sectional view showing a modification example of the trigger-type liquid sprayer according to the second embodiment of the present invention.

FIG. 10 is a rear view showing a restriction member in the modification example of the trigger-type liquid sprayer according to the second embodiment of the present invention.

### DESCRIPTION OF EMBODIMENTS

### First Embodiment

Hereinafter, a trigger-type liquid sprayer according to a first embodiment of the present invention will be described with reference to the drawings. This embodiment will be described using a spraying container in which the trigger-type liquid sprayer is mounted to a container body as an example.

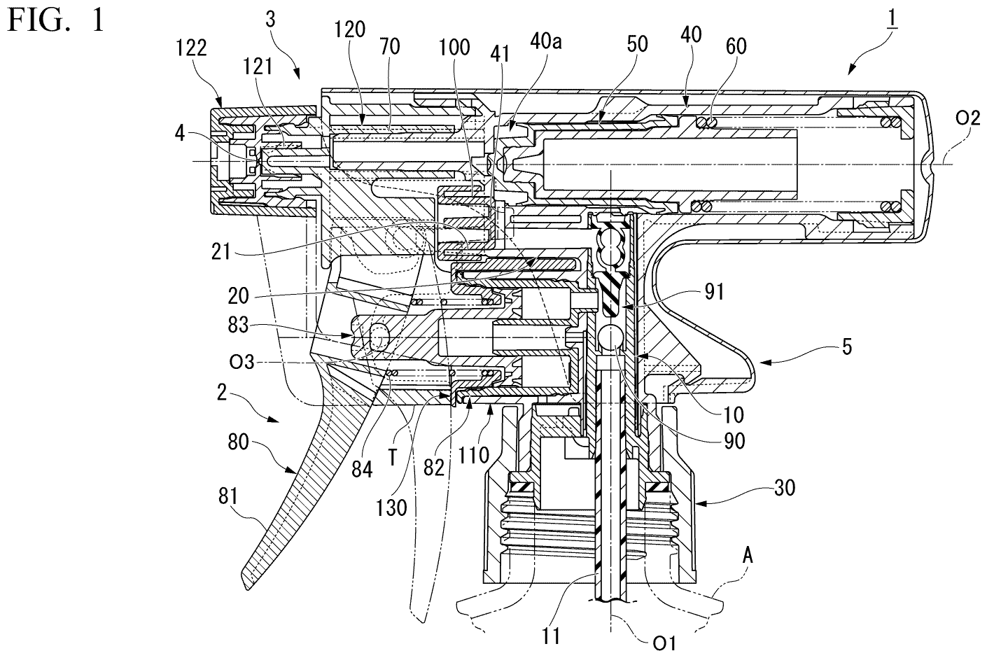

As shown in FIG. 1, a trigger-type liquid sprayer 1 of the present embodiment includes a sprayer main body 2 that is mounted to a container body A in which a liquid is accommodated, a nozzle member 3 in which a spray hole 4 for spraying the liquid is formed and which is mounted to the sprayer main body 2, and a cover body 5 that covers the sprayer main body 2 and the nozzle member 3. Each component of the trigger-type liquid sprayer 1 is a molded product made of a synthetic resin unless otherwise specified.

### (Sprayer Main Body)

The sprayer main body 2 mainly includes a vertical feed tube portion 10, a connection cylindrical part 20, an attachment cap 30, a reservoir cylinder 40, a reservoir plunger 50, a plunger biasing member 60, an injection cylindrical part 70, a trigger mechanism 80, a ball valve 90, and a reservoir valve 91.

In the present embodiment, the central axis of the vertical feed tube portion 10 is assumed to be an axis O1, the container body A side along the axis O1 is referred to as a lower side, the opposite side is referred to as an upper side, and a direction along the axis O1 is referred to as an up-down direction. Further, in a plan view seen in the up-down direction, one direction intersecting the axis O1 is referred to as a front-rear direction, and a direction orthogonal to both the up-down direction and the front-rear direction is referred to as a right-left direction.

Furthermore, in the present embodiment, the central axis of the reservoir cylinder 40 is assumed to be an axis O2. In the present embodiment, the axis O2 extends in the front-rear direction. Thus, in the present embodiment, the front-rear direction is equivalent to the axial direction along the central axis of the reservoir cylinder 40. In the present embodiment, the rear is equivalent to one side in the axial direction along the central axis of the reservoir cylinder 40, and the front is equivalent to the other side in the axial direction along the central axis of the reservoir cylinder 40. However, the axial direction along the axis O2 may not coincide with the front-rear direction.

The vertical feed tube portion 10 extends in the up-down direction and has a function of sucking up a liquid inside the container body A. The vertical feed tube portion 10 is mounted to the container body A by an attachment cap 30. The upper part of a pipe 11 that extends in the up-down direction and sucks up the liquid from the container body A is fitted to the vertical feed tube portion 10.

As shown in FIG. 1, a connection cylindrical part 20 that extends forward is provided at the upper end of the vertical feed tube portion 10. The connection cylindrical part 20 is formed in a cylindrical shape having an opening 21 that is open at the front of the sprayer main body 2, and communicates with the inside of the vertical feed tube portion 10. A closing plug 100 is mounted to the opening 21 of the connection cylindrical part 20, and the closing plug 100 closes (seals) the opening 21.

A cylinder cylindrical part 110 is provided below the connection cylindrical part 20 and above the attachment cap 30. The cylinder cylindrical part 110 protrudes forward from the vertical feed tube portion 10 and is open at the front. A main cylinder 82 is fitted into the cylinder cylindrical part 110. The main cylinder 82 is formed in a bottomed cylindrical shape that is open at the front and closed at the rear. The inside of the main cylinder 82 communicates with the inside of the vertical feed tube portion 10.

The reservoir cylinder 40 is disposed above the vertical feed tube portion 10 and the connection cylindrical part 20. Further, in the present embodiment, a lower end of the reservoir cylinder 40 is formed integrally with an upper end of the vertical feed tube portion 10 and an upper end of the connection cylindrical part 20. A liquid that has passed through the inside of the vertical feed tube portion 10 and the inside of the connection cylindrical part 20 is supplied into the reservoir cylinder 40 (a reservoir space 40a to be described later) due to the rearward swinging of a trigger part 81. Specifically, a supply hole 41 that communicates with the inside of the connection cylindrical part 20 is formed in a lower portion of a front end of the reservoir cylinder 40. The supply hole 41 is open in a portion located behind the closing plug 100, which will be described later. Thereby, it is possible to supply the liquid that has passed through the inside of the vertical feed tube portion 10 and the inside of the connection cylindrical part 20 into the reservoir cylinder 40 through the supply hole 41.

The reservoir plunger 50 is disposed within the reservoir cylinder 40 so as to be movable in the front-rear direction along the axis O2. Thereby, the reservoir plunger 50 tightly slides inside the reservoir cylinder 40 in the front-rear direction. The reservoir plunger 50 moves rearward according to the supply of the liquid into the reservoir cylinder 40. The reservoir plunger 50 blocks communication between the inside of the vertical feed tube portion 10 and the spray hole 4 through the inside of the connection cylindrical part 20, and allows communication between the inside of the vertical feed tube portion 10 and the spray hole 4 through the inside of the connection cylindrical part 20 when the reservoir plunger 50 is moved rearward. That is, the reservoir plunger 50 blocks communication between the inside of the vertical feed tube portion 10 and the spray hole 4 (inside the injection cylindrical part 70) through the inside of the connection cylindrical part 20 when the reservoir plunger 50 is located at the forwardmost position, and allows communication between the inside of the vertical feed tube portion 10 and the spray hole 4 (inside the injection cylindrical part 70) through the inside of the connection cylindrical part 20 when the reservoir plunger 50 is moved rearward from the forwardmost position. In the reservoir cylinder 40, a space located in front of the reservoir plunger 50 functions as the reservoir space 40a.

The reservoir space 40a stores the liquid that has passed through the inside of the vertical feed tube portion 10 and the inside of the connection cylindrical part 20 and has also passed through the supply hole 41. The reservoir space 40a expands as the reservoir plunger 50 moves rearward due to the supply of the liquid. The reservoir space 40a can also communicate with the inside of the injection cylindrical part 70, which will be described later.

The plunger biasing member 60 biases the reservoir plunger 50 forward. The plunger biasing member 60 is disposed behind the reservoir plunger 50 within the reservoir cylinder 40. The plunger biasing member 60 biases the reservoir plunger 50 forward in an initial state before the trigger part 81 is operated. Thereby, the reservoir plunger 50 is located at the forwardmost position. The plunger biasing member 60 is a metal coil spring disposed coaxially with the axis O2. However, for example, a resin spring or other elastic members may be used as the plunger biasing member 60.

In the reservoir cylinder 40 and the reservoir plunger 50 configured as described above, it is possible to pressurize the liquid within the reservoir space 40a until the reservoir plunger 50 moves rearward. Thereafter, when a hydraulic pressure in the reservoir space 40a reaches a predetermined value, the reservoir plunger 50 moves rearward against the plunger biasing member 60. Thereby, it is possible to supply the liquid in the reservoir space 40a to the spray hole 4 side. Thus, the reservoir plunger 50 can function as an accumulator valve.

The injection cylindrical part 70 extends forward from the reservoir cylinder 40. The injection cylindrical part 70 communicates with the inside of the vertical feed tube portion 10 through the inside of the reservoir cylinder 40 (reservoir space 40a) and the inside of the connection cylindrical part 20. Thereby, the injection cylindrical part 70 can guide the liquid that has passed through the inside of the vertical feed tube portion 10, the inside of the connection cylindrical part 20, and the inside of the reservoir cylinder 40 (reservoir space 40a) to the spray hole 4.

The trigger mechanism 80 includes the trigger part 81, the main cylinder 82, a main piston 83, and a coil spring 84 (biasing member). The trigger mechanism 80 can make the liquid flow from the inside of the vertical feed tube portion 10 through the inside of the connection cylindrical part 20 toward the spray hole 4 by rearward swinging of the trigger part 81.

The trigger part 81 is disposed in front of the vertical feed tube portion 10 so as to be movable rearward in a forward biased state. The trigger part 81 is formed to extend in the up-down direction and is disposed below the injection cylindrical part 70. An upper end of the trigger part 81 is pivotally supported by the nozzle member 3 so as to be swingable in the front-rear direction, and a lower end of the trigger part 81 is disposed in front of the main cylinder 82.

In the example shown in the drawing, a stopper T is provided in a gap between the trigger part 81 and the main cylinder 82 in the front-rear direction. The stopper T restricts the rearward swinging of the trigger part 81 by abutting on each of the trigger part 81 and the main cylinder 82. However, the stopper T is not essential and may not be provided.

The main piston 83 is disposed inside the main cylinder 82 so as to be movable in the front-rear direction. The main piston 83 is movable in the front-rear direction according to the swinging of the trigger part 81. Thereby, the inside of the main cylinder 82 is pressurized and depressurized according to the movement of the main piston 83 in the front-rear direction. The main piston 83 is formed in a topped cylindrical shape that is open at the rear and closed at the front.

The main piston 83 is biased forward via the trigger part 81 by a biasing force of the coil spring 84. The main piston 83 moves rearward according to the rearward swinging of the trigger part 81 and is pushed into the main cylinder 82. In addition, when the trigger part 81 is located at a forwardmost swinging position, the main piston 83 is located at the forwardmost position corresponding to the trigger part 81 located at the forwardmost swinging position.

The coil spring 84 is made of, for example, a metal. The coil spring 84 is disposed coaxially with the main piston 83 and the main cylinder 82 and biases the trigger part 81 forward, the trigger part 81 being a part to which the main piston 83 is connected. The coil spring 84 is disposed between the trigger part 81 and a spring receiver 130 mounted to an front opening of the main cylinder 82. However, the material of the coil spring 84 is not limited to a metal, and a resin spring or the like may be used, for example.

The ball valve 90 and the reservoir valve 91 are provided within the vertical feed tube portion 10. The ball valve 90 is configured as a check valve that blocks communication between the inside of the container body A and the inside of the main cylinder 82 through the inside of the vertical feed tube portion 10 when the inside of the main cylinder 82 is pressurized, and allows communication between the inside of the container body A and the inside of the main cylinder 82 through the inside of the vertical feed tube portion 10 by being displaced upward when the inside of the main cylinder 82 is depressurized.

The reservoir valve 91 is disposed above the ball valve 90. The reservoir valve 91 is configured as a check valve that allows a liquid to be supplied from the inside of the vertical feed tube portion 10 through the inside of the connection cylindrical part 20 into the reservoir cylinder 40, and restricts the outflow of the liquid from the inside of the reservoir cylinder 40 through the inside of the connection cylindrical part 20 into the vertical feed tube portion 10.

The cover body 5 is formed to cover the entire vertical feed tube portion 10 except for the lower end, the entire injection cylindrical part 70, and the entire reservoir cylinder 40 from at least both sides in the right-left direction and from above.

### (Nozzle Member)

The nozzle member 3 is assembled to the sprayer main body 2 mainly using the injection cylindrical part 70. The nozzle member 3 includes an attachment cylindrical part 120 that is externally fitted onto the injection cylindrical part 70 from the front, a nozzle shaft part 121 located inside a front end of the attachment cylindrical part 120, and a nozzle cap 122 that is mounted to the nozzle shaft part 121. In the nozzle cap 122, the spray hole 4 that opens forward and sprays a liquid forward.

### (Coil Spring)

In the trigger-type liquid sprayer 1 configured as described above, the arrangement of the coil spring 84 mentioned above and the structure around the coil spring 84 will be described.

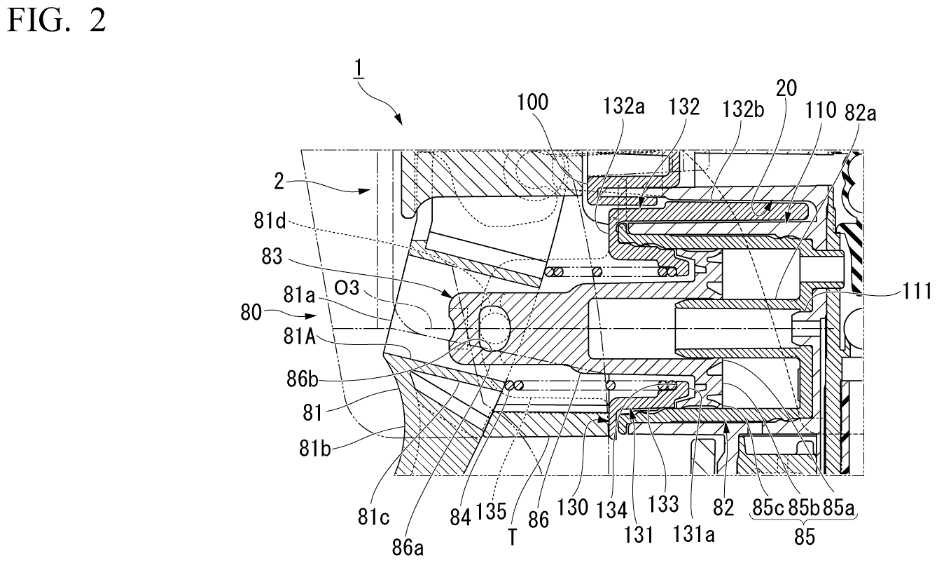

As shown in FIG. 2, the main cylinder 82, which has a bottomed cylindrical shape and opens forward, is provided with a cylindrical guide tube 82a that protrudes forward from the center portion of a rear wall part thereof. A front end of the guide tube 82a is located behind the front end of the main cylinder 82. The bottom of the guide tube 82a is formed in an annular shape. A fitting cylindrical part 111 provided in the cylinder cylindrical part 110 is fitted into the guide tube 82a. A front end of the fitting cylindrical part 111 protrudes into the guide tube 82a. The guide tube 82a is disposed coaxially with the fitting cylindrical part 111.

In the present embodiment, the coaxial central axis of the main cylinder 82, the guide tube 82a, the cylinder cylindrical part 110, and the fitting cylindrical part 111 extending in the front-rear direction is assumed to be an axis O3. Furthermore, in a plan view seen from the direction of the axis O3, a direction intersecting the axis O3 is referred to as a radial direction, and a direction circulating around the axis O3 is referred to as a circumferential direction.

The main piston 83 includes a sliding part 85 disposed inside the main cylinder 82 so as to be movable in the front-rear direction, and a protrusion part 86 that protrudes forward from the sliding part 85 toward the outside of the main cylinder 82 and has a front end 86a connected to the trigger part 81. The sliding part 85 is annularly provided at the rear end of the main piston 83 having a topped cylindrical shape. The guide tube 82a is inserted into the sliding part 85.

The sliding part 85 includes an inner lip part 85a that slides in contact with the outer circumferential surface of the guide tube 82a, a lip connection part 85b that extends radially outward from the inner lip part 85a, and an outer lip part 85c that extends radially outward from the lip connection part 85b and slides in contact with the inner circumferential surface of the main cylinder 82. The rear end of the inner lip part 85a extends radially inward and slides in contact with the outer circumferential surface of the guide tube 82a. Thereby, sealing performance is secured between the inner lip part 85a and the outer circumferential surface of the guide tube 82a.

The lip connection part 85b is formed in an annular shape that connects the inner lip part 85a and the outer lip part 85c in the radial direction. The front-facing surface of the lip connection part 85b is formed in a planar shape. The diameter of the outer lip part 85c expands from the outer circumferential end of the lip connection part 85b toward the front and rear, separately, and the outer lip part 85c is formed as a pair of front and rear parts and slides in contact with the inner circumferential surface of the main cylinder 82. Thereby, sealing performance is secured between the outer lip part 85c and the inner circumferential surface of the main cylinder 82.

The protrusion part 86 of the main piston 83 extends forward from the front end of the inner lip part 85a and protrudes outward from the front opening of the main cylinder 82. A pair of recesses 86b recessed in the right-left direction are formed in the front end 86a of the protrusion part 86. The recesses 86b are formed in a substantially arc shape or a substantially half-moon shape that extends in the up-down direction and is convex rearward. A connection shaft 81d provided in the trigger part 81 is inserted into the recess 86b from the right-left direction.

The trigger part 81 includes a pair of right and left side walls 81a, a front wall 81b that connects between the pair of right and left side walls 81a, and a plurality of reinforcement ribs 81c that connect the front wall 81b and the pair of right and left side walls 81a on the rear side of the front wall 81b. An opening 81A is formed in the front wall 81b. The connection shaft 81d is provided within the opening 81A and is connected to the front end 86a of the protrusion part 86 inserted into the opening 81A.

The coil spring 84 is disposed outside a space surrounded by the main cylinder 82 and the main piston 83, and biases the trigger part 81 forward in a state where the protrusion part 86 of the main piston 83 is inserted thereinto. The front end of the coil spring 84 abuts on the trigger part 81. In the present embodiment, the front end of the coil spring 84 abuts on the rear ends of the pair of right and left side walls 81a of the trigger part 81, the rear ends of the reinforcement ribs 81c disposed below the opening 81A, and the like.

A spring receiver that receives the front end of the coil spring 84 on a flat surface may be provided on the rear side of the trigger part 81. However, the protrusion part 86 of the main piston 83 is inserted into the coil spring 84, and the posture of the coil spring 84 is restricted. For this reason, there is no problem even when the front end of the coil spring 84 obliquely abuts on the trigger part 81 as in the present embodiment. Further, there is no problem even when the coil spring 84 is disposed to be curved at the intermediate portion in the front-rear direction.

The spring receiver 130 that receives the rear end of the coil spring 84 is mounted to the front opening of the main cylinder 82. The spring receiver 130 is formed in an annular shape coaxial with the axis O3. The spring receiver 130 includes an inner cylindrical part 131 that is inserted into the main cylinder 82 and a locking part 132 that is connected to the inner cylindrical part 131, extends to the outside of the cylinder cylindrical part 110 in the radial direction, and is locked to the outside of the cylinder cylindrical part 110.

The locking part 132 includes an extending part 132a extending upward from the upper front end of the inner cylindrical part 131, and an insertion part 132b extending rearward from the upper end of the extending part 132a. The upper end of the extending part 132a extends upward from the upper end of the cylinder cylindrical part 110. The insertion part 132b is inserted into a gap between the cylinder cylindrical part 110 and the connection cylindrical part 20 on the outside of the cylinder cylindrical part 110 in the radial direction. A step is provided on the upper surface side of the insertion part 132b so as to face the closing plug 100 in the front-rear direction.

The inner cylindrical part 131 is inserted into the main cylinder 82 and extends rearward from a position where it is connected to the locking part 132. The outer circumferential surface of the inner cylindrical part 131 is disposed to be spaced apart from the entire inner circumferential surface of the main cylinder 82. That is, the inner cylindrical part 131 is suspended via the locking part 132 and positioned in the front-rear direction. The diameter of a rear end 131a of the inner cylindrical part 131 slightly decreases with respect to the inner circumferential surface of the main cylinder 82.

The rear end 131a of the inner cylindrical part 131 faces the lip connection part 85b in the front-rear direction and restricts forward coming-out of the main piston 83. A groove part 133 extending in the front-rear direction is formed on the outer circumferential surface of the inner cylindrical part 131. The groove part 133 is formed at least at a lower part of the outer circumferential surface of the inner cylindrical part 131 so as to have a fixed depth. The groove part 133 forms a gap extending in the front-rear direction between the outer circumferential surface of the inner cylindrical part 131 and the inner circumferential surface of the main cylinder 82. The gap extends to the front opening of the main cylinder 82.

The protrusion part 86 of the main piston 83 is inserted into the inner cylindrical part 131 in the front-rear direction. Further, a receiving part 134 that receives the rear end of the coil spring 84 is formed inside the inner cylindrical part 131. The receiving part 134 is a step formed on the front surface side of the rear end 131a of the inner cylindrical part 131, and is formed in an annular shape coaxial with the axis O3.

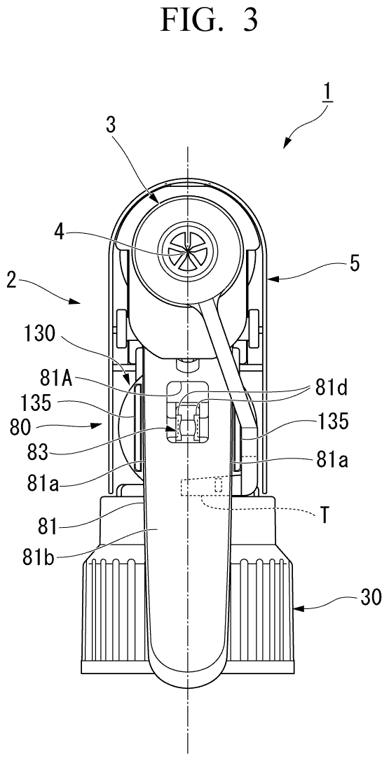

The spring receiver 130 having the above-described configuration is provided with a pair of side wall parts 135 that protrude forward and sandwich the coil spring 84 in the right-left direction. The pair of side wall parts 135 cover the coil spring 84 from both right and left sides. Further, the pair of side wall parts 135 extend in the front-rear direction along the coil spring 84. The front ends of the pair of side wall parts 135 are disposed to sandwich the trigger part 81 in the right-left direction. As shown in FIG. 3, the pair of side wall parts 135 are plate members having a thickness in the right-left direction, and guide the pair of right and left side walls 81a of the trigger part 81 in the front-rear direction.

### (Operations of Trigger-Type Liquid Sprayer)

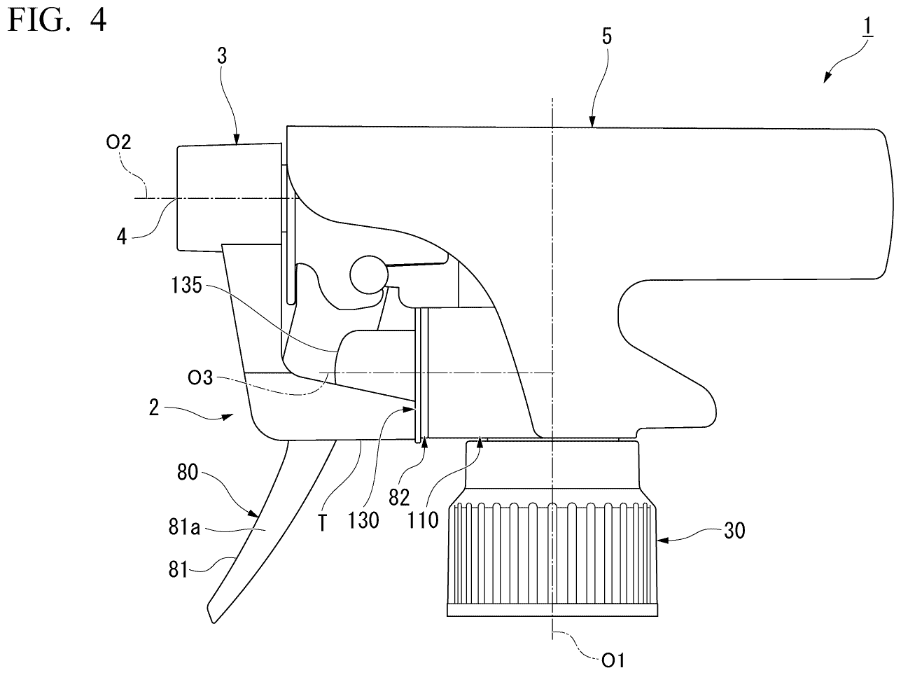

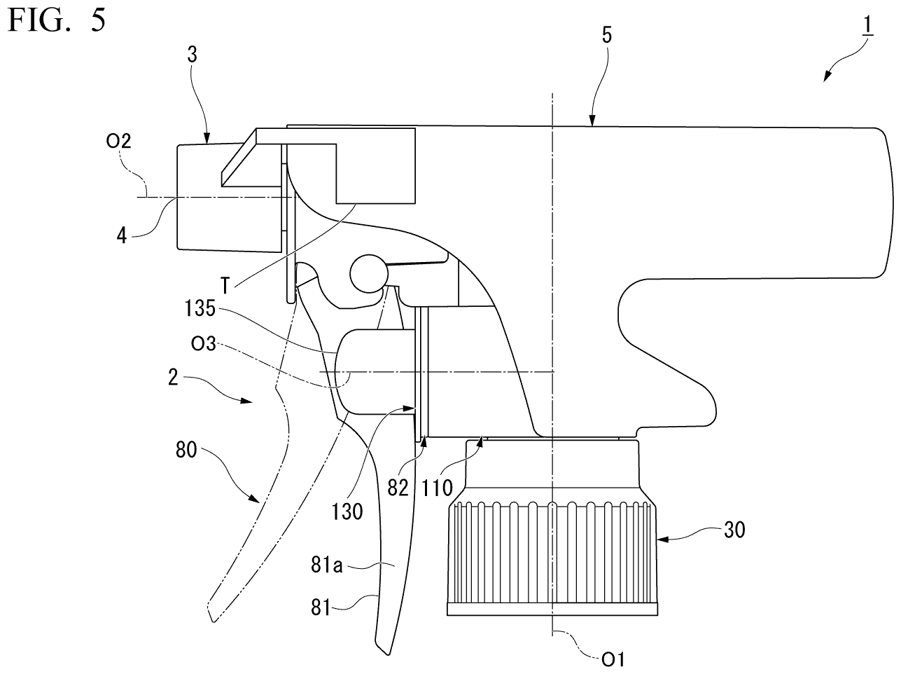

Next, a case where the trigger-type liquid sprayer 1 configured as described above is used will be described. First, the movement restriction of the trigger part 81 by the stopper T is released from the state shown in FIG. 4. Next, as shown in FIG. 5, the trigger part 81 is operated to be pulled rearward against a biasing force of the coil spring 84 (see FIG. 1). By operating the trigger part 81 a plurality of times, the trigger-type liquid sprayer 1 is set to be in a state where each part of the trigger-type liquid sprayer 1 is filled with a liquid, and the liquid can be sucked up into the vertical feed tube portion 10.

When the trigger part 81 is operated to be pulled rearward against the biasing force of the coil spring 84, the main piston 83 moves rearward from the forwardmost position, and the inside of the main cylinder 82 is pressurized. Thereby, a liquid in the main cylinder 82 is supplied to the vertical feed tube portion 10. The liquid supplied to the vertical feed tube portion 10 presses the ball valve 90 downward and also pushes the reservoir valve 91 upward.

Thereby, the liquid in the vertical feed tube portion 10 can be supplied to the reservoir space 40a of the reservoir cylinder 40 through the inside of the connection cylindrical part 20 and the supply hole 41, and the reservoir space 40a can be pressurized. For this reason, as the reservoir space 40a is pressurized, the reservoir plunger 50 can be moved rearward from the most advanced position against a biasing force of the plunger biasing member 60, and the liquid can be stored (filled) in the reservoir space 40a. When the reservoir plunger 50 is moved rearward, the liquid in the reservoir space 40a of which the pressure has increased can be guided to the spray hole 4 through the inside of the injection cylindrical part 70. Thereby, the liquid can be sprayed forward from the spray hole 4.

As described above, it is possible to spray the liquid from the spray hole 4 each time an operation of pulling the trigger part 81 rearward is performed, and to store the liquid in the reservoir space 40a by moving the reservoir plunger 50 rearward.

Thereafter, when the trigger part 81 is released, the trigger part 81 is restored and moved forward due to an elastic restoring force (biasing force) of the coil spring 84, and thus the main piston 83 connected to the trigger part 81 is also restored and moved forward inside the main cylinder 82. For this reason, the inside of the main cylinder 82 can be depressurized to a pressure lower than the pressure inside the container body A, and thus the ball valve 90 can be raised while the reservoir valve 91 remains closed. Thus, the liquid in the container body A can be sucked up into the vertical feed tube portion 10 and introduced into the main cylinder 82. Thereby, it is possible to prepare for the next spraying.

When the rearward operation of the trigger part 81 is stopped, the supply of the liquid to the reservoir space 40a through the inside of the vertical feed tube portion 10 and the inside of the connection cylindrical part 20 is stopped, and the reservoir plunger 50 begins to move forward toward the most advanced position due to the biasing force of the plunger biasing member 60. At this time, the outflow of the liquid from the reservoir space 40a into the vertical feed tube portion 10 is restricted by the reservoir valve 91.

Thereby, the liquid accumulated in the reservoir space 40a can be guided to the spray hole 4 through the inside of the injection cylindrical part 70, and the liquid can be continuously sprayed forward through the spray hole 4. In this manner, the liquid can be sprayed not only when the trigger part 81 is pulled rearward, but also when the trigger part 81 is not operated, and the liquid can be sprayed continuously.

As described above, according to the trigger-type liquid sprayer 1 of the present embodiment, a liquid can be sprayed not only when the trigger part 81 is pulled rearward but also when the trigger part 81 is not operated, and the liquid can be sprayed continuously. The upper end (fulcrum) of the trigger part 81 is pivotally supported by the nozzle member 3 so as to be swingable, and the main piston 83 is connected to an intermediate portion (point of action) of the trigger part 81. Thereby, for example, by operating the lower end (point of force) of the trigger part 81, the main piston 83 can be efficiently moved using the principle of leverage. For this reason, the operability of the trigger part 81 can be improved.

Furthermore, according to the trigger-type liquid sprayer 1 of the present embodiment, the trigger part 81 is biased forward by the coil spring 84 as shown in FIG. 2. In particular, the protrusion part 86 of the main piston 83 is inserted into the coil spring 84, the protrusion part 86 protruding outward from the front opening of the main cylinder 82 and having the front end 86a connected to the trigger part 81. Thus, the trigger part 81 can be biased by disposing the coil spring 84 outside a space surrounded by the main cylinder 82 and the main piston 83. Thereby, a liquid sucked up into the main cylinder 82 does not come into contact with the coil spring 84 and thus does not react. Thus, it is possible to configure the trigger-type liquid sprayer 1 that prevents deterioration of the coil spring 84 and degradation of the liquid and is suitable for continuous spraying of the liquid.

As described above, the trigger-type liquid sprayer 1 according to the present embodiment includes the sprayer main body 2 mounted to the container body A in which a liquid is accommodated, and the nozzle member 3 which is mounted to the sprayer main body 2 and in which the spray hole 4 for spraying the liquid is formed. The sprayer main body 2 includes the vertical feed tube portion 10 that sucks up the liquid in the container body A, the trigger mechanism 80 that includes the trigger part 81 disposed to be movable rearward in a forward biased state and makes the liquid flow from the inside of the vertical feed tube portion 10 toward the spray hole 4 by the rearward movement of the trigger part 81, the reservoir cylinder 40 into which the liquid having passed through the inside of the vertical feed tube portion 10 is supplied by the rearward movement of the trigger part 81, and the reservoir plunger 50 that is disposed within the reservoir cylinder 40 so as to be movable in the axial direction along the central axis of the reservoir cylinder 40, is moved to one side in the axial direction according to the supply of the liquid into the reservoir cylinder 40, and is biased toward the other side. The trigger mechanism 80 includes the main cylinder 82 that opens at the front and communicates with the inside of the vertical feed tube portion 10 at the rear, the main piston 83 that includes the sliding part 85 disposed inside the main cylinder 82 so as to be movable in the front-rear direction and the protrusion part 86 protruding forward from the sliding part 85 toward the outside of the main cylinder 82 and having the front end 86a connected to the trigger part 81, and the coil spring 84 into which the protrusion part 86 of the main piston 83 is inserted and which biases the trigger part 81 forward. According to this configuration, it is possible to suppress a contact between the coil spring 84 that biases the trigger part 81 and a liquid and to continuously spray the liquid.

Further, in the present embodiment, the spring receiver 130 that is mounted to the front opening of the main cylinder 82 and receives the rear end of the coil spring 84 is provided. According to this configuration, the spring receiver 130 can be mounted to the front opening of the main cylinder 82, and the coil spring 84 can be disposed between the spring receiver 130 and the trigger part 81. Further, the spring receiver 130 can restrict coming-out of the main piston 83 from the front opening of the main cylinder 82.

Further, in the present embodiment, the spring receiver 130 includes the pair of side wall parts 135 that sandwich the coil spring 84 in the right-left direction. According to this configuration, the coil spring 84 disposed outside a space surrounded by the main cylinder 82 and the main piston 83 is sandwiched between the pair of right and left side wall parts 135 to make it difficult to view the coil spring 84 from the outside, and the design can be improved (see FIGS. 4 and 5). Furthermore, it is possible to prevent a liquid or the like scattered by spraying from adhering to the coil spring 84 by the pair of right and left side wall parts 135. Furthermore, it is possible to suppress diagonal pulling (pulling for twisting a pivotally supporting part of the trigger part 81) of the trigger part 81 by the pair of right and left side wall parts 135.

Further, in the present embodiment, the spring receiver 130 includes the inner cylindrical part 131 inserted into the main cylinder 82, the receiving part 134 formed inside the inner cylindrical part 131 and receiving the rear end of the coil spring 84, and the groove part 133 formed outside the inner cylindrical part 131 and forming a gap extending in the front-rear direction between the outer circumferential surface of the inner cylindrical part 131 and the inner circumferential surface of the main cylinder 82. According to this configuration, the inner cylindrical part 131 of the spring receiver 130 is inserted into the main cylinder 82, and thus the spring receiver 130 can be easily mounted to the main cylinder 82. Furthermore, it is possible to restrict forward coming-out of the main piston 83 sliding inside the main cylinder 82 by the inner cylindrical part 131 inserted into the main cylinder 82. Furthermore, since a gap extending in the front-rear direction is formed between the outer circumferential surface of the inner cylindrical part 131 and the inner circumferential surface of the main cylinder 82 by the groove part 133 formed in the inner cylindrical part 131 of the spring receiver 130, even when a liquid leaks from the gap between the inner circumferential surface of the main cylinder 82 and the sliding contact portion of the main piston 83 that slides on the inner circumferential surface, the liquid comes out through the gap on the outer side of the inner cylindrical part 131, and thus it is possible to suppress flow-around of the liquid to the receiving part 134 that receives the rear end of the coil spring 84 inside the inner cylindrical part 131 and to suppress a contact between the coil spring 84 and the liquid.

Although the first embodiment of the present invention has been described above, the first embodiment is presented as an example of the present invention, and is not intended to limit the scope of the invention. The embodiments of the present invention can be implemented in various other forms, and various omissions, substitutions, and changes can be made without departing from the gist of the invention. The embodiments and their modification examples include, for example, those that can be easily assumed by those skilled in the art, those that are substantially the same, and those that are equivalent.

For example, a case where the spring receiver 130 is mounted to the front opening of the main cylinder 82 has been described in the above-described embodiment as an example, but the spring receiver 130 that receives the rear end of the coil spring 84 may not be mounted. In this case, for example, the rear end of the coil spring 84 may be received on the front surface side of the lip connection part 85b of the main piston 83.

Further, for example, a case where diagonal pulling of the trigger part 81 is suppressed by the pair of right and left side wall parts 135 has been described in the above-described embodiment as an example, but the pair of right and left side wall parts 135 may have only a cover function for covering the coil spring 84 instead of having a guide function for the trigger part 81.

Further, for example, only one locking part 132 of the spring receiver 130 may be formed, or a plurality of locking parts 132 may be formed at intervals in the circumferential direction. Furthermore, when only one locking part 132 is formed, the locking part 132 may be configured in a cylindrical shape that surrounds the cylinder cylindrical part 110 from the outside in the radial direction. In addition, the locking part 132 may be locked to the cylinder cylindrical part 11 by screwing the locking part 132 to the outer circumferential surface of the cylinder cylindrical part 110, or the like.

In addition, it is possible to appropriately replace the components in the above-described embodiment with well-known components without departing from the spirit of the present invention.

### Second Embodiment

Hereinafter, a trigger-type liquid sprayer according to a second embodiment of the present invention will be described with reference to the drawings. In the following description, a spraying container in which the trigger-type liquid sprayer is mounted to a container body is exemplified.

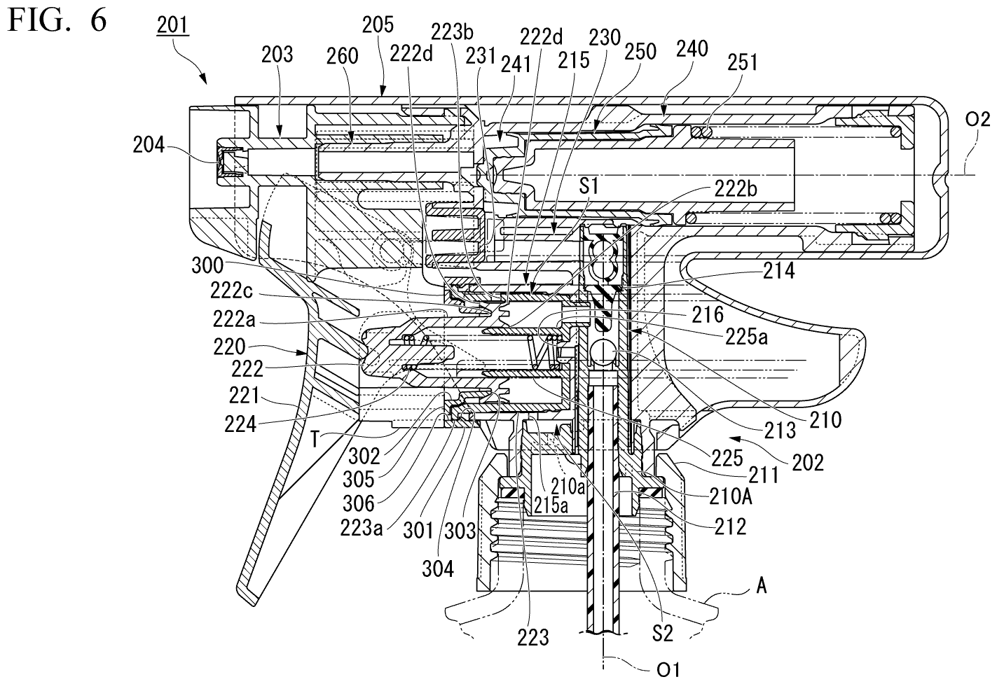

As shown in FIG. 6, a trigger-type liquid sprayer 201 of the present embodiment includes a sprayer main body 202 that is mounted to a container body A in which a liquid is accommodated, a nozzle member 203 in which a spray hole 204 for spraying the liquid is formed and which is mounted to the sprayer main body 202, and a cover member (cover body) 205 that covers the sprayer main body 202 and the nozzle member 203. Each component of the trigger-type liquid sprayer 201 is a molded product made of a synthetic resin unless otherwise specified.

The sprayer main body 202 mainly includes a vertical feed tube portion 210, a trigger mechanism 220, a connection cylindrical part 230, a reservoir cylinder 240, a reservoir plunger 250, and an injection cylindrical part 260. In the following description, the central axis of the vertical feed tube portion 210 is assumed to be an axis O1, the container body A side along this axis O1 is referred to as a lower side, the opposite side is referred to as an upper side, and a direction along the axis O1 is referred to as an up-down direction. Further, in a plan view seen in the up-down direction, one direction intersecting the axis O1 is referred to as a front-rear direction, and a direction orthogonal to both the up-down direction and the front-rear direction is referred to as a right-left direction.

Furthermore, the central axis of the reservoir cylinder 240 is assumed to be an axis O2. In the present embodiment, the axis O2 extends in the front-rear direction. In the present embodiment, the front-rear direction is equivalent to the axial direction along the central axis of the reservoir cylinder 240. In the present embodiment, the rear is equivalent to one side in the axial direction along the central axis of the reservoir cylinder 240, and the front is equivalent to the other side in the axial direction along the central axis of the reservoir cylinder 240. However, the axial direction along the axis O2 may not coincide with the front-rear direction.

The vertical feed tube portion 210 extends in the up-down direction and sucks up a liquid in the container body A. The vertical feed tube portion 210 is mounted to the container body A by an attachment cap 211. The upper part of a pipe 212 that extends in the up-down direction and sucks up the liquid from the container body A is fitted to the vertical feed tube portion 210. A first check valve 213 (ball valve) and a second check valve 214 (reservoir valve) are provided above the fitting position of the pipe 212 in the vertical feed tube portion 210.

The first check valve 213 blocks communication between the inside of the container body A and the inside of a main cylinder 223 through the inside of the vertical feed tube portion 210 when the inside of the main cylinder 223 of the trigger mechanism 220 is pressurized, and allows communication between the inside of the container body A and the inside of the main cylinder 223 through the inside of the vertical feed tube portion 210 by being displaced upward when the inside of the main cylinder 223 is depressurized.

The second check valve 214 is disposed above the first check valve 213. The second check valve 214 allows a liquid to be supplied from the inside of the vertical feed tube portion 210 into the reservoir cylinder 240 and restricts the outflow of the liquid from the inside of the reservoir cylinder 240 into the vertical feed tube portion 210.

A cylinder cylindrical part 215 is provided on the front side of the vertical feed tube portion 210. The cylinder cylindrical part 215 protrudes forward from the vertical feed tube portion 210 and is open forward. The main cylinder 223 is fitted into the cylinder cylindrical part 215. The main cylinder 223 is formed in a bottomed cylindrical shape that is open at the front and closed at the rear. The main cylinder 223 communicates with a space between the first check valve 213 and the second check valve 214 in the vertical feed tube portion 210 at a part of the rear wall part thereof.

The trigger mechanism 220 includes a trigger part 221, a main piston 222, a main cylinder 223, and a piston biasing member 224 (biasing member). The trigger mechanism 220 can make the liquid flow from the inside of the vertical feed tube portion 210 toward the spray hole 204 by moving the trigger part 221 rearward.

The trigger part 221 is disposed in front of the vertical feed tube portion 210 so as to be movable rearward in a forward biased state. The trigger part 221 is pivotally supported by the nozzle member 203 below the injection cylindrical part 260 so as to be swingable in the front-rear direction. The trigger part 221 extends downward from the position where the trigger part 221 is supported by the nozzle member 203, and is located in front of the main piston 222 and the main cylinder 223.

In the present embodiment, a stopper T is detachably provided in a gap between the trigger part 221 and the main cylinder 223 in the front-rear direction. The stopper T restricts the rearward swinging of the trigger part 221 by abutting on each of the trigger part 221 and the main cylinder 223. The stopper T may be in a removed state.

The main piston 222 is disposed inside the main cylinder 223 so as to be movable in the front-rear direction. The main piston 222 is movable in the front-rear direction according to the movement of the trigger part 221. The inside of the main cylinder 223 is pressurized and depressurized according to the movement of the main piston 222 in the front-rear direction. The main piston 222 is formed in a topped cylindrical shape that is open at the rear and closed at the front.

The main piston 222 is biased forward together with the trigger part 221 by a biasing force of the piston biasing member 224. The main piston 222 retreats and is pushed into the main cylinder 223 according to the rearward movement of the trigger part 221. When the trigger part 221 is located at a forwardmost swinging position, the main piston 222 is located at the forwardmost position corresponding to the trigger part 221 located at the forwardmost swinging position.

The piston biasing member 224 is a metal spring. The piston biasing member 224 is disposed coaxially with the main piston 222 and the main cylinder 223, and biases the trigger part 221 forward via the main piston 222. The piston biasing member 224 is disposed between a top wall of the main piston 222 and a bottom wall of the main cylinder 223. The material of the piston biasing member 224 is not limited to a metal, and a resin spring or the like may be used, for example.

The connection cylindrical part 230 is disposed above the cylinder cylindrical part 215. The connection cylindrical part 230 extends forward from an upper end of the vertical feed tube portion 210. The inside of the connection cylindrical part 230 communicates with a side above a closed position of the second check valve 214 in the vertical feed tube portion 210. A closing plug 231 is fitted to the front end of the connection cylindrical part 230. The liquid flowing forward inside the connection cylindrical part 230 hits the closing plug 231 and changes its direction upward, and flows into the reservoir cylinder 240 through a gap between the closing plug 231 and the upper end of the connection cylindrical part 230.

The reservoir cylinder 240 is disposed above the vertical feed tube portion 210 and the connection cylindrical part 230. The lower end of the reservoir cylinder 240 in the present embodiment is formed integrally with the upper end of the vertical feed tube portion 210 and the upper end of the connection cylindrical part 230. The liquid having passed through the inside of the vertical feed tube portion 210 and the inside of the connection cylindrical part 230 is supplied into the reservoir cylinder 240 (reservoir space 241) by the rearward movement of the trigger part 221.

The reservoir plunger 250 is disposed within the reservoir cylinder 240 so as to be movable in the front-rear direction along the axis O2. The reservoir plunger 250 slides within the reservoir cylinder 240 in the front-rear direction. At the forwardmost position, the reservoir plunger 250 blocks communication between the inside of the vertical feed tube portion 210 and the spray hole 204 (the inside of the injection cylindrical part 260). When the reservoir plunger 250 moves rearward from the forwardmost position, the inside of the vertical feed tube portion 210 and the spray hole 204 (the inside of the injection cylindrical part 260) communicate with each other. In the reservoir cylinder 240, a space located in front of the reservoir plunger 250 functions as the reservoir space 241.

The liquid having passed through the vertical feed tube portion 210 is stored in the reservoir space 241. The reservoir space 41 expands as the reservoir plunger 250 moves rearward due to the supply of the liquid. The reservoir plunger 250 moves rearward according to the supply of the liquid into the reservoir cylinder 240. The reservoir space 241 communicates with the inside of the vertical feed tube portion 210 through the connection cylindrical part 230. The reservoir space 241 can also communicate with the inside of the injection cylindrical part 260. When the reservoir plunger 250 is located at the forwardmost position, communication between the reservoir space 241 and the inside of the injection cylindrical part 260 is blocked. When the reservoir plunger 250 retreats from the forwardmost position, the reservoir space 241 communicates with the inside of the injection cylindrical part 260.

A plunger biasing member 251 that biases the reservoir plunger 250 forward is provided inside the reservoir cylinder 240. The plunger biasing member 251 is disposed behind the reservoir plunger 250 within the reservoir cylinder 240. In the initial state before a user operates the trigger part 221, the plunger biasing member 251 biases the reservoir plunger 250 forward, and thus the reservoir plunger 250 is located at the forwardmost position. The plunger biasing member 251 is configured as a metal coil spring disposed coaxially with the axis O2. However, the plunger biasing member 251 may be made of, for example, a resin spring or other elastic members.

The liquid is pressurized in the reservoir space 241 of the reservoir cylinder 240 until the reservoir plunger 250 moves rearward. When a hydraulic pressure in the reservoir space 241 reaches a predetermined value, the reservoir plunger 250 moves rearward against the plunger biasing member 251. Thereby, it is possible to supply the liquid in the reservoir space 241 to the spray hole 204 side. The reservoir plunger 250 functions as an accumulator valve.

The injection cylindrical part 260 extends forward from the reservoir cylinder 240. The injection cylindrical part 260 communicates with the inside of the vertical feed tube portion 210 through the inside of the reservoir cylinder 240 (reservoir space 241) and the inside of the connection cylindrical part 230. The injection cylindrical part 260 guides the liquid having passed through the inside of the vertical feed tube portion 210, the inside of the connection cylindrical part 230, and the inside of the reservoir cylinder 240 (reservoir space 241) to the spray hole 204. The nozzle member 203 is externally fitted to the injection cylindrical part 260 from the front. In the nozzle member 203, the spray hole 204 that opens forward and sprays the liquid forward is formed.

The cover member 205 is formed to cover the entire vertical feed tube portion 210 except for the lower end, the entire injection cylindrical part 260, and the entire reservoir cylinder 240 from at least both sides in the right-left direction and from above.

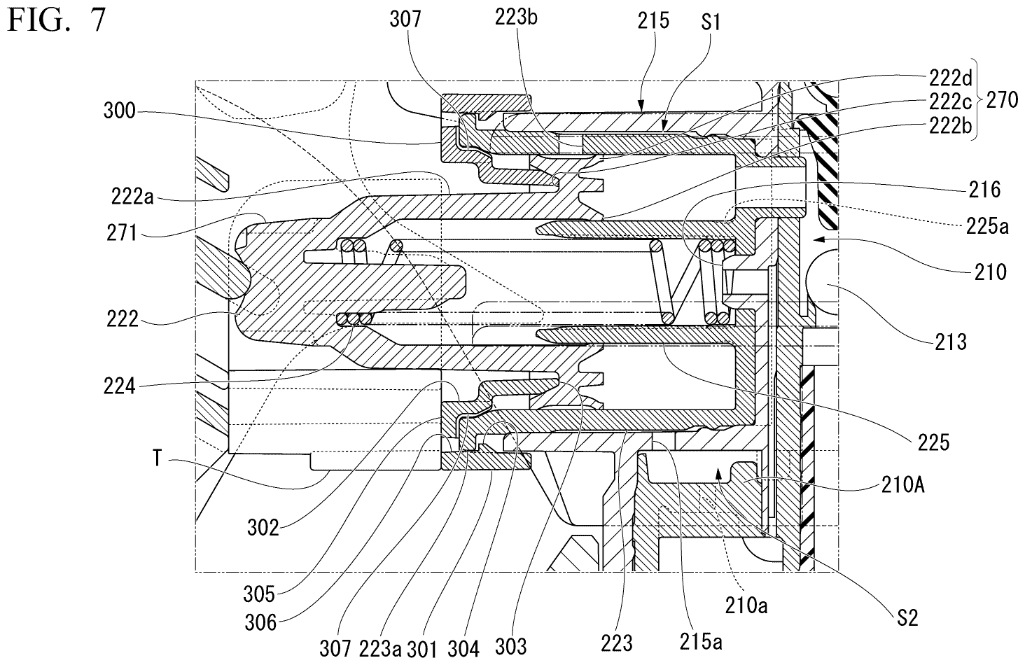

The trigger-type liquid sprayer 201 configured as described above includes a restriction member 300 that is fitted to the main cylinder 223 and restricts forward coming-out of the main piston 222. As shown in an enlarged view of FIG. 7, the restriction member 300 includes an outer cylindrical part 301 that is externally fitted to the main cylinder 223, an inner cylindrical part 302 that is connected to the outer cylindrical part 301, inserted into the main cylinder 223, and disposed on the entire circumference of the inner wall surface of the main cylinder 223 with a gap therebetween, and a restriction piece 303 that protrudes rearward from the inner cylindrical part 302.

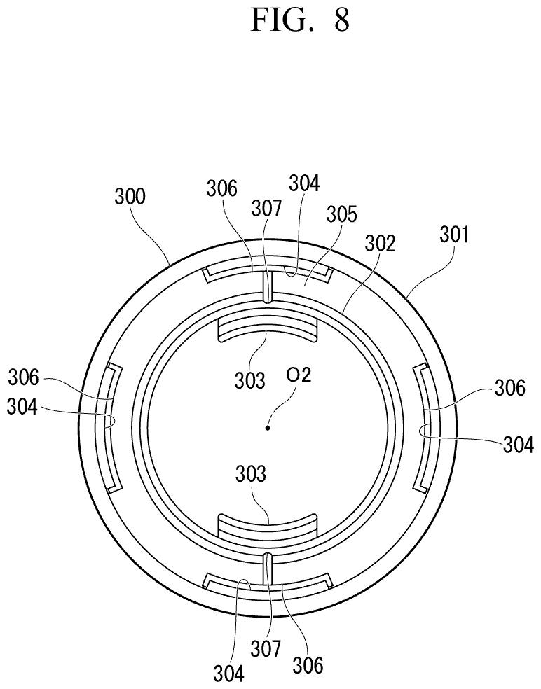

A fitting piece 304 is provided to protrude on the inner circumferential surface of the outer cylindrical part 301. As shown in a rear view of the restriction member 300 in FIG. 8, a plurality of fitting pieces 304 are provided at intervals in the circumferential direction of the outer cylindrical part 301 (in the present embodiment, four fitting pieces 304 are provided at intervals of 90° around the axis O2). As shown in FIG. 7, the fitting piece 304 abuts on a flange 223a provided at a front end opening of the main cylinder 223 from the rear.

The outer diameter of the flange 223a is the same as the outer diameter of the cylinder cylindrical part 215. The flange 223a is disposed with a gap in the front-rear direction with respect to a front end opening edge of the cylinder cylindrical part 215. The fitting piece 204 is disposed to fit in the gap between the flange 223a and the front end opening edge of the cylinder cylindrical part 215. In this manner, the outer diameters of the main cylinder 223 and the cylinder cylindrical part 215 can be minimized by providing a gap between the flange 223a and the front end opening edge of the cylinder cylindrical part 215 and fitting the fitting piece 304 of the restriction member 300 into the gap.

The front end of the outer cylindrical part 301 and the front end of the inner cylindrical part 302 are connected by an annular connection part 305. The annular connection part 305 abuts on the front end opening edge of the main cylinder 223 including a front-facing surface of the flange 223a from the front. A through hole 306 (forming hole) for forming the fitting piece 304 is formed in the annular connection part 305 at a position facing the fitting piece 304 in the front-rear direction.

The inner cylindrical part 302 extends rearward from an inner end edge of the annular connection part 305 in the radial direction. The outer circumferential surface of the inner cylindrical part 302 is disposed to be spaced apart from the entire circumference of the inner wall surface of the main cylinder 223. That is, the inner cylindrical part 302 is suspended from the outer cylindrical part 301 via the annular connection part 305 and positioned in the front-rear direction. The diameter of the rear end side of the outer circumferential surface of the inner cylindrical part 302 slightly decreases in accordance with the shape of the inner wall surface of the main cylinder 223.

As shown in FIG. 8, a pair of groove parts 307 extending in the front-rear direction are formed on the outer circumferential surface of the inner cylindrical part 302. The pair of groove parts 307 are formed above and below the outer circumferential surface of the inner cylindrical part 302 so as to have a fixed depth. The pair of groove parts 307 extend to a rear-facing surface of the annular connection part 305 and extend to the through holes 306 disposed above and below the groove parts.

As shown in FIG. 7, the main cylinder 223, which has a bottomed cylindrical shape and opens forward, is provided with a cylindrical guide tube 225 that protrudes forward from the center portion of a rear wall part thereof. The guide tube 225 is formed in a bottomed cylindrical shape that is open at the front and closed at the rear. A front end of the guide tube 225 is located behind a front end of the main cylinder 223.

The bottom of the guide tube 225 is formed in an annular shape, and a fitting cylindrical part 216 provided in the cylinder cylindrical part 215 is fitted into the guide tube 225. The front end of the fitting cylindrical part 216 protrudes into the guide tube 225. The guide tube 225 is disposed coaxially with the fitting cylindrical part 216. An annular recess 225a is formed on the outer circumferential surface of the rear end of the guide tube 225.

The main piston 222 includes a piston main body 222a which is open at the rear and into which the guide tube 225 is inserted, and an inner lip part 222b that is provided at the rear end of the piston main body 222a and slides in contact with an outer wall surface of the guide tube 225, a lip connection part 222c that protrudes radially outward from the rear end of the piston main body 222a, and a pair of front and rear outer lip parts 222d that are connected to the radially outer side of the lip connection part 222c and slide in contact with the inner wall surface of the main cylinder 223.

The piston main body 222a is formed in the shape of a capped cylinder that is open at the rear and closed at the front. The inner diameter of the piston main body 222a is slightly larger than the outer diameter of the guide tube 225. A front end 271 of the piston main body 222a is locked to the trigger part 221 by abutting on the trigger part 221 from the rear of the trigger part 221 (see FIG. 6).

Additionally, the main piston 222 can also be described as follows. The main piston 222 includes a sliding part 270 disposed inside the main cylinder 223 so as to be movable in the front-rear direction, and the piston main body (protrusion part) 222a that protrudes forward from the sliding part 270 toward the outside of the main cylinder 223 and in which the front end 271 is connected to the trigger part 221. The sliding part 270 includes the inner lip part 222b, the lip connection part 222c, and the outer lip parts 222d.

The annular inner lip part 222b that protrudes radially inward and slides in contact with the outer wall surface of the guide tube 225 is formed at the rear end of the piston main body 222a. Thereby, sealing performance is secured between the inner lip part 222b and the outer wall surface of the guide tube 225. The inner lip part 222b reaches the recess 25a when the main piston 222 is located at the rearmost position.

When the inner lip part 222b reaches the recess 225a of the guide tube 25, a slight gap is formed between the inner lip part 222b and the recess 225a. Through this gap, the inside of the main cylinder 223 communicates with the gap between the inner circumferential surface of the piston main body 222a and the outer wall surface of the guide tube 225. Thereby, the inside of the main cylinder 223 communicates with the inside of the fitting cylindrical part 216 through the inside of the guide tube 225.

The lip connection part 222c is formed in an annular shape that connects the inner lip part 222b and the outer lip part 222d in the radial direction. A front-facing surface of the lip connection part 222c is a flat surface. The diameter of the outer lip part 222d expands from the outer circumferential end of the lip connection part 222c toward the front and rear, separately, and the outer lip part 222d is formed as a pair of front and rear parts and slides in contact with the inner wall surface of the main cylinder 223. Thereby, sealing performance is secured between the outer lip part 222d and the inner wall surface of the main cylinder 223.

The main piston 222 is located at the forwardmost position corresponding to the trigger part 221 located at a forwardmost swinging position when the trigger part 221 is located at the forwardmost swinging position. At this time, the main piston 222 closes a first vent hole 223b formed in the main cylinder 223 between the pair of front and rear outer lip parts 222d. Then, when the main piston 222 moves rearward by a predetermined amount from the forwardmost position due to rearward swinging of the trigger part 221, the main piston 222 opens the first vent hole 223b.

Thereby, the first vent hole 223b is opened to the outside of the trigger-type liquid sprayer 201 through the inside of the main cylinder 223. The first vent hole 223b communicates with the inside of the container body A through various gaps and various vent holes (a first gap S1, a second vent hole 215a, a second gap S2, and a third vent hole 210a). Thereby, the inside of the container body A from which a liquid has been sprayed can be replaced with air. The first gap S1 is an annular gap formed between the inner circumferential surface of the cylinder cylindrical part 215 and the outer circumferential surface of the main cylinder 223. Further, the second vent hole 215a is a through hole formed in a peripheral wall of the cylinder cylindrical part 215 and extends downward from a lower part of the first gap S1. The second gap S2 is a gap formed between a lower surface of the cylinder cylindrical part 215 and an upper surface of an inner cylinder side flange part 210A of the vertical feed tube portion 210, and communicates with a lower end of the second vent hole 215a. As shown in FIG. 6, the attachment cap 211 is locked to the inner cylinder side flange part 210A. The third vent hole 210a is a through hole that vertically penetrates the inner cylinder side flange part 210A and allows communication between the second gap S2 and the inside of the container body A.

The restriction member 300 includes a restriction piece 303 that abuts on the lip connection part 222c in the front-rear direction to restrict forward coming-out of the main piston 222. As shown in a rear view of the restriction member 300 in FIG. 8, a plurality of restriction pieces 303 are provided at intervals in the circumferential direction of the inner cylindrical part 302 (in the present embodiment, two restriction pieces 303 are provided at intervals of 180° around the axis O2). As shown in FIG. 7, the restriction piece 303 is provided to protrude rearward from the inner circumferential surface side of the rear end of the inner cylindrical part 302. The diameter of the outer circumferential surface side of the rear end of the restriction piece 303 decrease rearward. The rear end surface of the restriction piece 303 is a flat surface parallel to the lip connection part 222c and faces the lip connection part 222c in the front-rear direction.

### (Operations of Trigger-Type Liquid Sprayer)

Next, a case where the trigger-type liquid sprayer 201 configured as described above is used will be described. By operating the trigger part 221 a plurality of times, the trigger-type liquid sprayer 201 is set to be in a state where each part of the trigger-type liquid sprayer 201 is filled with a liquid, and the liquid can be sucked up into the vertical feed tube portion 210.

A user removes the stopper T and then performs an operation of pulling the trigger part 221 rearward against a biasing force of the piston biasing member 224. Then, the main piston 222 moves rearward from the forwardmost position, and the inside of the main cylinder 223 is pressurized. Thereby, a liquid in the main cylinder 223 is supplied to the vertical feed tube portion 210. Then, the liquid supplied to the vertical feed tube portion 210 presses the first check valve 213 downward and pushes the second check valve 214 upward.

Thereby, the liquid in the vertical feed tube portion 210 can be supplied to the reservoir space 241 of the reservoir cylinder 240 through the inside of the connection cylindrical part 230, and the reservoir space 241 can be pressurized. For this reason, as the reservoir space 241 is pressurized, the reservoir plunger 250 can be moved rearward from the most advanced position against a biasing force of the plunger biasing member 251, and the liquid can be stored (filled) in the reservoir space 241.

When the reservoir plunger 250 is moved rearward, the liquid in the reservoir space 241 of which the pressure has increased can be guided to the spray hole 204 through the inside of the injection cylindrical part 260. Then, the liquid can be sprayed forward from the spray hole 204. In this manner, it is possible to spray the liquid from the spray hole 204 each time an operation of pulling the trigger part 221 rearward is performed, and to store the liquid in the reservoir space 241 by moving the reservoir plunger 250 rearward.

Thereafter, when the trigger part 221 is released, the main piston 222 is restored and moved forward inside the main cylinder 223 due to an elastic restoring force (biasing force) of the piston biasing member 224, and thus the trigger part 221 is also restored and moved forward. For this reason, the inside of the main cylinder 223 can be depressurized to a pressure lower than the pressure inside the container body A, and thus the first check valve 213 can be raised while the second check valve 214 remains closed. Thus, the liquid in the container body A can be sucked up into the vertical feed tube portion 210 and introduced into the main cylinder 223. Thereby, it is possible to prepare for the next spraying.

When the rearward operation of the trigger part 221 is stopped, the supply of the liquid to the reservoir space 241 through the inside of the vertical feed tube portion 210 and the inside of the connection cylindrical part 230 is stopped, and the reservoir plunger 250 begins to move forward toward the most advanced position due to the biasing force of the plunger biasing member 251. At this time, the outflow of the liquid from the reservoir space 241 into the vertical feed tube portion 210 is restricted by the second check valve 214.

Thereby, the liquid accumulated in the reservoir space 241 can be guided to the spray hole 204 through the inside of the injection cylindrical part 260, and the liquid can be continuously sprayed forward through the spray hole 204. In this manner, the liquid can be sprayed not only when the trigger part 221 is pulled rearward, but also when the trigger part 221 is not operated, and the liquid can be sprayed continuously.

According to the trigger-type liquid sprayer 201 configured as described above, when the trigger mechanism 220 is operated and the trigger part 221 is moved rearward, the inside of the main cylinder 223 is pressurized due to the retreat of the main piston 222, and the liquid in the main cylinder 223 flows from the inside of the vertical feed tube portion 210 toward the spray hole 204. Thereby, the liquid can be sprayed forward through the spray hole 204 of the nozzle member 203. Furthermore, when the operation of the trigger mechanism 220 is stopped, the main piston 222 moves forward together with the trigger part 221 to depressurize the inside of the main cylinder 223 because the piston biasing member 224 biasing the main piston 222 forward is provided inside the main cylinder 223, and the liquid can be sucked up from the inside of the container body A. Here, the restriction member 300 is fitted to the main cylinder 223, and forward coming-out of the main piston 222 is directly restricted by the restriction member 300. For this reason, even when the trigger part 221 is not yet assembled, the forward movement of the main piston 222 can be reliably restricted.

That is, when the biasing force of the piston biasing member 224 is increased in order to strengthen the sucking-up of the liquid into the main cylinder 223, the main piston 222 tends to move forward. When the forward movement of the main piston 222 is restricted only by the trigger part 221, the forward movement of the main piston 222 cannot be completely restricted because it depends on the assembly accuracy and deformation of the trigger part 221. When the main piston 222 moves forward beyond a designed forwardmost position, there is a possibility of liquid leakage or the like. Further, when the main piston 222 moves forward beyond the designed forwardmost position, there is a possibility that the main piston 222 will not retreat to a designed rearmost position at the time of performing an operation of pulling the trigger part 221. Furthermore, when the outer lip part 222d passes through the first vent hole 223b for air replacement due to the forward movement of the main piston 222, a liquid infiltrates into the first vent hole 23b, and there is a possibility that the infiltrating liquid will flow backward and will be sprayed at the time of performing an operation of pulling the trigger part 221. In order to suppress such a possibility, in the present embodiment, a ring-shaped restriction member 300 is fitted to the flange 223a of the main cylinder 223, thereby directly pressing the main piston 222 and reliably restricting its forward movement. Further, the main cylinder 223, the piston biasing member 224, the main piston 222, and the restriction member 300 can be assembled into a unit in advance by fitting the restriction member 300, and thus the main cylinder 223, the piston biasing member 224, the main piston 222, and the restriction member 300 can be easily assembled to the sprayer main body 202.

In this manner, the trigger-type liquid sprayer 201 according to the present embodiment described above includes the sprayer main body 202 mounted to the container body A in which a liquid is accommodated, and the nozzle member 203 which is disposed on the front side of the sprayer main body 202 and in which the spray hole 204 for spraying the liquid forward is formed. The sprayer main body 202 includes the vertical feed tube portion 210 that extends in the up-down direction and sucks up the liquid in the container body A, the trigger mechanism 20 that includes the trigger part 221 disposed in front of the vertical feed tube portion 210 so as to be movable rearward in a forward biased state and makes the liquid flow from the inside of the vertical feed tube portion 210 toward the spray hole 204 by the rearward movement of the trigger part 221, the reservoir cylinder 240 into which the liquid having passed through the inside of the vertical feed tube portion 210 from the main cylinder 223 is supplied by the rearward movement of the trigger part 221, and the reservoir plunger 250 that is disposed within the reservoir cylinder 240 so as to be movable in the axial direction along the central axis of the reservoir cylinder 240, is moved to one side in the axial direction according to the supply of the liquid into the reservoir cylinder 240, and is biased toward the other side. The trigger mechanism 220 includes the main piston 222 that moves back and forth according to the movement of the trigger part 221, the main cylinder 223 of which the inside is pressurized and depressurized according to the movement of the main piston 222 and communicates with the inside of the vertical feed tube portion 210, the piston biasing member 224 that is disposed inside the main cylinder 223 and biases the main piston 222 forward, and the restriction member 300 that is fitted to the main cylinder 223 and restricts forward coming-out of the main piston 222. According to this configuration, the forward movement of the main piston 222 can be restricted regardless of the assembled state of the trigger part 221.

Further, the trigger-type liquid sprayer 201 according to the present embodiment can also be described as follows. The trigger-type liquid sprayer 201 according to the present embodiment includes the sprayer main body 202 mounted to the container body A in which a liquid is accommodated, and the nozzle member 203 which is mounted to the sprayer main body 202 and in which the spray hole 204 for spraying the liquid is formed. The sprayer main body 202 includes the vertical feed tube portion 210 that sucks up the liquid in the container body A, the trigger mechanism 220 that includes the trigger part 221 disposed to be movable rearward in a forward biased state and makes the liquid flow from the inside of the vertical feed tube portion 210 toward the spray hole 204 by the rearward movement of the trigger part 221, the reservoir cylinder 240 into which the liquid having passed through the inside of the vertical feed tube portion 210 is supplied by the rearward movement of the trigger part 221, and the reservoir plunger 250 that is disposed within the reservoir cylinder 240 so as to be movable in the axial direction along the central axis of the reservoir cylinder 240, is moved to one side in the axial direction according to the supply of the liquid into the reservoir cylinder 240, and is biased toward the other side. The trigger mechanism 220 includes the main cylinder 223 that opens at the front and communicates with the inside of the vertical feed tube portion 210 at the rear, the main piston 222 that includes the sliding part 270 disposed inside the main cylinder 223 so as to be movable in the front-rear direction and the piston main body 222a (protrusion part) protruding forward from the sliding part 270 toward the outside of the main cylinder 223 and having the front end 271 connected to the trigger part 221, the biasing member (piston biasing member) 224 that biases the trigger part 221 forward, and the restriction member 300 that is fitted to the main cylinder 223 and restricts forward coming-out of the main piston 222. According to this configuration, the forward movement of the main piston 222 can be restricted regardless of the assembled state of the trigger part 221. The biasing member (piston biasing member) 224 is disposed inside the main cylinder 223.

Furthermore, in the present embodiment, the guide tube 225 that guides the main piston 222 in the front-rear direction is provided inside the main cylinder 223. The main piston 222 includes the inner lip part 222b that slides on the outer wall surface of the guide tube 225, the outer lip part 222d that slides on the inner wall surface of the main cylinder 223, and the lip connection part 222c that connects the inner lip part 222b and the outer lip part 222d. The restriction member 300 includes the restriction piece 303 that abuts on the lip connection part 222c in the front-rear direction to restrict forward coming-out of the main piston 222. According to this configuration, the restriction piece 303 of the restriction member 300 directly abuts on the lip connection part 222c, which connects the inner lip part 222b and the outer lip part 222d of the main piston 222, in the front-rear direction, and thus it is possible to restrict the forward movement of the main piston 222 while preventing deformation of the inner lip part 222b and the outer lip part 222d. For this reason, it is possible to secure sliding performance and sealing performance of the main piston 222 with respect to the guide tube 225 and the main cylinder 223.

Further, in the present embodiment, the restriction member 300 includes the outer cylindrical part 301 that is externally fitted to the main cylinder 223, the inner cylindrical part 302 that is connected to the outer cylindrical part 301, inserted into the main cylinder 223, and disposed on the entire circumference of the inner wall surface of the main cylinder 223 with a gap therebetween, and the pair of groove parts 307 that are formed on the outer circumferential surface of the inner cylindrical part 302 and extend in the front-rear direction. According to this configuration, the outer cylindrical part 301 of the restriction member 300 is externally fitted to the main cylinder 223. For this reason, the restriction member 300 can be easily mounted to the main cylinder 223. Further, the inner cylindrical part 302 of the restriction member 300 is inserted into the main cylinder 223 and is disposed on the entire circumference of the inner wall surface of the main cylinder 223 with a gap therebetween, and the pair of groove parts extending in the front-rear direction are formed on the outer circumferential surface of the inner cylindrical part 302. For this reason, the inner cylindrical part 302 can be inserted to a predetermined position within the main cylinder 223 to restrict the forward movement of the main piston 222 regardless of the dimensional accuracy of the inner wall surface of the main cylinder 223.

Further, in the present embodiment, the piston biasing member 224 is a metal spring, and the sprayer main body 202 includes the reservoir cylinder 240 into which the liquid having passed through the inside of the vertical feed tube portion 210 from the main cylinder 223 is supplied by the rearward movement of the trigger part 221, the reservoir plunger 250 that is disposed within the reservoir cylinder 240 so as to be movable in the axial direction along the central axis of the reservoir cylinder 240, is moved to one side in the axial direction according to the supply of the liquid into the reservoir cylinder 240, and is biased toward the other side, the first check valve 213 that blocks communication between the inside of the container body A and the inside of the main cylinder 223 through the inside of the vertical feed tube portion 210 when the inside of the main cylinder 223 is pressurized, and allows communication between the inside of the container body A and the inside of the main cylinder 223 through the inside of the vertical feed tube portion 210 when the inside of the main cylinder 223 is depressurized, and the second check valve 214 that allows communication between the inside of the reservoir cylinder 240 and the inside of the main cylinder 223 through the inside of the vertical feed tube portion 210 when the inside of the main cylinder 223 is pressurized, and blocks communication between the inside of the reservoir cylinder 240 and the inside of the main cylinder 223 through the inside of the vertical feed tube portion 210 when the inside of the main cylinder 223 is depressurized. According to this configuration, the piston biasing member 224 is configured as a metal spring, and thus it is possible to strengthen the sucking-up of the liquid into the main cylinder 223. In addition, it is possible to spray the liquid through the spray hole 204 while supplying the liquid into the reservoir cylinder 240 through the inside of the vertical feed tube portion 210 from the main cylinder 223 by using the first check valve 213 and the second check valve 214 and to pressurize the inside of the reservoir cylinder 240. Thus, the reservoir plunger 250 can be pressed toward one side in the axial direction against a forward biasing force, and the reservoir plunger 250 can be moved toward one side in the axial direction while spraying the liquid. For this reason, each time an operation of pulling the trigger part 221 is performed, the reservoir plunger 250 is moved to one side in the axial direction, and the liquid can be sprayed while storing (filling) the liquid in the reservoir cylinder 240. When the operation of the trigger part 221 is stopped after filling the reservoir cylinder 240 with the liquid, the supply of the liquid into the reservoir cylinder 240 through the vertical feed tube portion 210 is stopped, but the reservoir plunger 250 begins to be restored and moved toward the other side in the axial direction. Thereby, the liquid filled in the reservoir cylinder 240 can be pushed out from the inside of the reservoir cylinder 240 toward the spray hole 204 and can be sprayed from the spray hole 4. Thus, it is possible to continuously spray the liquid.

Although the second embodiment of the present invention has been described above, the second embodiment is presented as an example of the present invention, and is not intended to limit the scope of the invention. The embodiments of the present invention can be implemented in various other forms, and various omissions, substitutions, and changes can be made without departing from the gist of the invention. The embodiments and their modification examples include, for example, those that can be easily assumed by those skilled in the art, those that are substantially the same, and those that are equivalent.

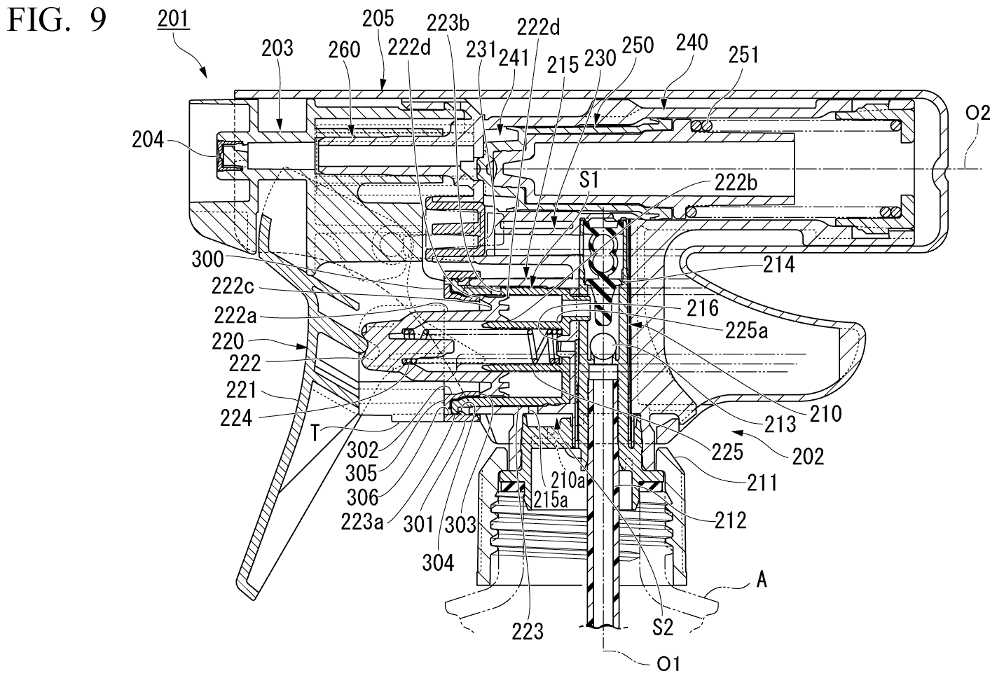

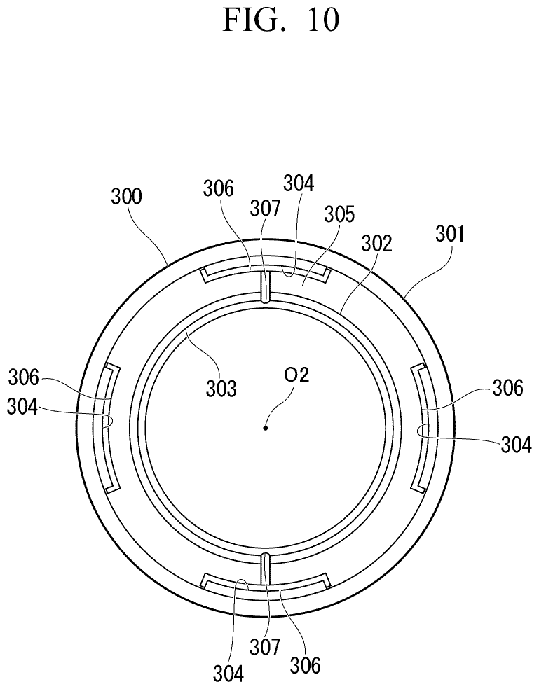

For example, a modification example as shown in FIG. 9 may be adopted. A restriction member 300 shown in FIG. 9 abuts on an outer lip part 222d on a front side out of a pair of front and rear outer lip parts 222d in the front-rear direction to restrict forward coming-out of a main piston 222. As shown in a rear view of FIG. 10, the restriction member 300 adopts a configuration in which a rear end formed continuously over the entire circumference of an inner cylindrical part 302 also serves as a restriction piece 303. Even with the above-described configuration, the forward movement of the main piston 222 can be restricted regardless of the assembled state of a trigger part 221. Further, the restriction member 300 may adopt a configuration in which the restriction piece 303 shown in FIG. 7 is spaced radially inward from the inner circumferential surface of the outer lip part 222d and abuts on only a lip connection part 222c. Further, the restriction member 300 may not have a ring shape.

Furthermore, the reservoir cylinder 240 and the reservoir plunger 250 may not be provided. The trigger-type liquid sprayer 201 may not be designed to perform continuous spraying.

In addition, it is possible to appropriately replace the components in the above-described embodiment with well-known components without departing from the spirit of the present invention.

According to a trigger-type liquid sprayer according to the present invention, it is possible to suppress a contact between a biasing member that biases a trigger part and a liquid, to continuously spray the liquid, and to restrict forward movement of a main piston regardless of an assembled state of the trigger part.

### REFERENCE SIGNS LIST

1, 201 Trigger-type liquid sprayer
2, 202 Sprayer main body
3, 203 Nozzle member
4, 204 Spray hole
5, 205 Cover body (cover member)
10, 210 Vertical feed tube portion
11, 212 Pipe
20, 230 Connection cylindrical part
21 Opening
30, 211 Attachment cap
40, 240 Reservoir cylinder
40a, 241 Reservoir space
41 Supply hole
50, 250 Reservoir plunger
60, 251 Plunger biasing member
70, 260 Injection cylindrical part
80, 220 Trigger mechanism
81, 221 Trigger part
81a Side wall
81A Opening
81b Front wall
81c Reinforcement rib
81d Connection shaft
82, 223 Main cylinder
82a, 225 Guide tube
83, 222 Main piston
84 Coil spring (biasing member)
224 Piston biasing member (biasing member)
85, 270 Sliding part
85a, 222b Inner lip part
85b, 222c Lip connection part
85c, 222d Outer lip part
86, 222a Protrusion part (piston main body)
86a, 271 Front end
86b Recess
90, 213 Ball valve (first check valve)
91, 214 RESERVOIR valve (second check valve)
100, 231 Closing plug
110, 215 Cylinder cylindrical part
111, 216 Fitting cylindrical part
120 Attachment cylindrical part
121 Nozzle shaft part
122 Nozzle cap
130 Spring receiver (spring receiver)
131, 302 Inner cylindrical part
131a Rear end
132 Locking part
132a Extending part
132b Insertion part
133, 307 Groove part
134 Receiving part
135 Side wall part
210a Third vent hole
215a Second vent hole
223a Flange
223b First vent hole
225a Recess
300 Restriction member
301 Outer cylindrical part
302 Inner cylindrical part
306 Through hole
303 Restriction piece
304 Fitting piece
305 Annular connection part
306 Through hole
A Container body
O1 Axis
O2 Axis
O3 Axis
T Stopper
S1 First gap
S2 Second gap

1. A trigger-type liquid sprayer comprising:
a sprayer main body mounted to a container body in which a liquid is accommodated; and
a nozzle member mounted to the sprayer main body, and provided with a spray hole through which the liquid is sprayed,
wherein the sprayer main body includes:
a vertical feed tube portion configured to suck up the liquid in an inside of the container body,
a trigger mechanism having a trigger part disposed to be movable rearward in a forward biased state, and configured to flow the liquid toward the spray hole from an inside of the vertical feed tube portion according to rearward movement of the trigger part,
a reservoir cylinder into which the liquid passing through the inside of the vertical feed tube portion is supplied according to the rearward movement of the trigger part, and
a reservoir plunger disposed in an inside of the reservoir cylinder to be movable in an axial direction along a central axis of the reservoir cylinder, configured to move toward one side in the axial direction according to supply of the liquid into the inside of the reservoir cylinder, and biased toward the other side, and
the trigger mechanism includes:
a main cylinder opening at a front, and communicating with the inside of the vertical feed tube portion at a rear,
a main piston that includes:
a sliding part disposed in an inside of the main cylinder to be movable in a front-rear direction, and
a protrusion part protruding forward from the sliding part toward an outside of the main cylinder, and a front end of which is connected to the trigger part, and
a biasing member into which the protrusion part of the main piston is inserted, and biasing the trigger part forward.

2. The trigger-type liquid sprayer according to claim 1, further comprising:
a spring receiver that is mounted to an opening of the main cylinder at the front thereof, and configured to receive a rear end of the biasing member.

3. The trigger-type liquid sprayer according to claim 2, wherein the spring receiver includes a pair of side wall parts sandwiching the biasing member in a right-left direction.

4. The trigger-type liquid sprayer according to claim 2, wherein the spring receiver includes
an inner cylindrical part that is inserted into the main cylinder, and
a receiving part that is formed in an inside of the inner cylindrical part, and configured to receive the rear end of the biasing member.

5. The trigger-type liquid sprayer according to claim 3, wherein the spring receiver includes
an inner cylindrical part that is inserted into the main cylinder, and
a receiving part that is formed in an inside of the inner cylindrical part, and configured to receive the rear end of the biasing member.
